(19) United States
(12) Patent Application Publication
(10) Pub. No.: US 2026/0275081 A1
(43) Pub. Date: Sep. 17, 2026

(54) MICROPOROUS POWDER COMPOSITION AND INSULATION PRODUCT

(71) Applicant: PRTC NV, Tisselt (BE)

(72) Inventor: Oras ABDUL-KADER, Sint Niklaas (BE)

(21) Appl. No.: 19/469,579

(22) PCT Filed: Mar. 28, 2024
(86) PCT No.: PCT/EP2024/058701

§ 371 Date: Sep. 26, 2025

(30) Foreign Application Priority Data
Mar. 31, 2023 (EP) 23166012.7
Feb. 6, 2024 (EP) 24155918.6

(51) Int. Cl. C08K 7/26; C08K 9/08; C09C 1/00; C09C 3/04; C09C 3/10

(52) U.S. Cl. CPC C08K 7/26; C08K 9/08; C09C 1/0081; C09C 3/045; C09C 3/10; C01P 2004/34; C01P 2004/50; C01P 2004/61; C01P 2006/11; C01P 2006/32

(57) ABSTRACT

The microporous powder composition comprises an insulation powder chosen from alumina and silica, and an opacifier and a filler, wherein the filler is a hollow microsphere of inorganic material. The hollow microspheres may have a median particle size in the range of up to 100 μm, preferably 40-80 μm. The microporous powder composition may be fiber-free and is configured for use in granulates. The granules may be coated, wherein the microspheres provide good adhesion from the coating material to the microporous granules.

### FIELD OF THE INVENTION

The invention relates to a microporous powder composition, comprising an insulation powder chosen from alumina and silica, an opacifier and a filler.

The invention further relates to an insulation product comprising a microporous powder composition.

The invention moreover relates to the use of a microporous powder composition 8 for the manufacture of an insulation product.

### BACKGROUND OF THE INVENTION

Microporous insulation materials are known per se, for instance from GB1580909 and U.S. Pat. No. 6,936,326, and comprise a porous silica material which generally is either a pyrogenic silica or aerogel, and in addition thereto an opacifier and optionally a reinforcing fiber. In ASTM C168, microporous insulation is defined as “material in the form of compacted powder or fibres with an average interconnecting pore size comparable or below the mean free path of air molecules at standard atmospheric pressure. Microporous insulation may contain opacifiers to reduce the amount of radiant heat transmitted”. Microporous materials are characterized by a very low thermal conductivity of less than 40 mW/m·K and even significantly lower and are often used as thin insulating panel in a variety of industrial applications as well as in construction. In the context of the present application, reference will be made to a microporous powder composition as a synonym for a microporous insulation material.

The microporous insulation materials may be encapsulated in a rigid or flexible envelope. Such enveloped insulation product can be an insulation panel, but can alternatively be a block or the like. The microporous material may alternatively be provided within a barrier material which is then drawn to vacuum. The latter panel is known per se as a vacuum insulation panel or VIP. A further insulation product comprising microporous material is a granulate. The granules offer the advantage that these can fill up a space of any complex shape and act therein as insulating material. This turns out advantageous in applications such as heaters, fuel cells and other thermal apparatus, wherein a certain part of the apparatus will operate at relatively high temperature, typically between 300 and 1000° C., while other portions of the apparatus should not heat up too much, for instance to avoid any burning by a user. The granules may here be inserted into channels, cavities and other shapes so as to enable appropriate insulation.

Microporous powder compositions for the preparation of granulates are known from WO2006/097668A1. The disclosed compositions are fiber-free, as fibers result in relatively large voids between the granules. Such relatively large voids (as compared to the microporous voids within a microporous powder) would cause the thermal conductivity of the resulting material to be high relative to large continuous bodies of comparable insulation. The granulates were prepared on the basis of a powder composition comprising 30-95% dry weight microporous insulating material (i.e. pyrogenic silica), 5-70% dry weight infrared opacifying material, 0-50% particulate insulating filler material, and 0-5% binder material. Examples of particulate insulating filler materials are vermiculite, perlite, flyash, volatilized silica and mixtures thereof. These materials are silica- and silica-based materials, with SiO2 contents of 36-42%, 70-75%, 40-55% and 100%. Vermiculite, perlite and flyash moreover contain significant amounts of alumina. Overall, these renders the particulate filler materials similar in chemical composition to the basic material of the microporous powder composition, i.e. pyrogenic silica and pyrogenic alumina. Still, the addition of 12% thereof had a significant effect on the shrinkage after a 24 hours heat treatment at 900° C. Without filler this shrinkage was less than 2.0%. With volatilized silica as filler, it was 5.5% When using 12% of precipitated silica, it was even 7.1%.

US2020/0031720A1 furthermore discloses methods for manufacturing hydrophobic granules of microporous material. The methods comprise densification of a microporous powder comprising hydrophilic silica to provide granular material, followed by a pre-treatment step and a hydrophobation step in which the granular material is hydrophobized with a hydrophobizing agent. In one method, the pre-treatment step is a heating step, preferably to 800 to 1100° C., with 3 hours hold time according to the example; in another method, the pre-treatment step is a treatment with ammonia. However, ammonia is a high health hazard compound according to US government as it is corrosive to skin, eyes and lung. It is furthermore flammable in concentrations of 15% or more in air. And a high-temperature treatment is difficult to implement in production, and the granules tend to sinter at these temperatures, comprising performance. Additionally, a high-temperature treatment adds costs, so that it is not desired.

### SUMMARY OF THE INVENTION

It is therefore an object of the invention to provide a microporous powder composition for use in granulates, which has acceptable properties with respect to thermal conductivity and high-temperature shrinkage, and wherein the granular material is or can be rendered hydrophobic in a rather straightforward manner.

It is another object to provide a granulate comprising a microporous powder, that is or can be rendered hydrophobic.

It is a further object to provide use of the microporous powder composition in generating a granulate, especially a hydrophobic granulate.

According to a first aspect, the invention provides a microporous powder composition, comprising an insulation powder chosen from alumina and silica, and an opacifier and a filler, wherein the filler is a hollow microsphere or inorganic material.

According to a second aspect, the invention provides an insulation product comprising the microporous powder composition of the invention, wherein the insulation product is a granulate.

According to a third aspect, the invention provides a filled polymer resin material comprising an insulation filler, wherein said insulation filler is an insulation product of the invention.

According to a further aspect, the invention provides a use of the microporous powder composition of the invention for the manufacture of an insulation product, wherein the manufacture comprises granulation.

According to again a further aspect, the invention provides a method of manufacturing a granulate, wherein a microporous powder composition of the invention is provided and compacted into a granulate and optionally coated.

According to another aspect, the invention provides a method of providing a hydrophobic granulate of microporous material, comprising the step of coating a granulate comprising a microporous powder composition of the invention with a hydrophobic coating agent, such as a silicon compound or a silicone resin.

It has been found in investigations leading to the invention that the use of microspheres as fillers in microporous material provides decent key properties, such as thermal conductivity and thermal shrinkage and facilitates coating of the granules, due to better adhesion to the microspheres. Typical examples include glass microspheres and cenospheres.

In one embodiment, the microsphere comprises at least 88% by weight of oxides chosen from silica and alumina. In a further embodiment, the microsphere comprises at least 90% by weight of oxides chosen from silica and alumina. Examples of such materials include aluminosilicate glasses, perlite, silica. Due to high purity hereof, there is less risk of contamination of the microporous composition, which often leads to deterioration of thermal properties such as high temperature shrinkage and/or thermal conductivity at temperatures well above room temperature, such as at 400° C.

In again a further embodiment, the microsphere comprises at most 9% by weight of alkaline oxides, more preferably at most 7% by weight. Alkaline oxides such as sodium oxide (Na₂O) and potassium oxide (K₂O) are contaminants susceptible of deterioration of thermal properties of microporous powders. The alkaline ions may diffuse quickly through the composition, and the alkalinity may give rise to condensation reactions of the insulation powder, such as pyrogenic silica. It is however believed that the microsphere form of the material hinders diffusion of alkaline oxides incorporated into the microsphere.

In one preferred implementation, the filler is a perlite microsphere. Good results have been obtained herewith in experiments, and such microspheres are commercially available with a preferred size distribution. Such microspheres for instance comprise 75-85 wt % SiO2 and 10-20 wt % Al₂O₃, for instance 78-82 wt % SiO2 and 11-15 wt % Al₂O₃.

In an embodiment, the microsphere has a mean particle size (d50) as determined by laser diffraction in the range of 25-90 μm, preferably 40-80 μm. Such mean particle size corresponds well to the agglomerate size of the insulation powder. This allows adequate mixing and hence appropriate uniform distribution of the microsphere filler into the microporous material. Smaller microsphere particles are moreover beneficial, so as to achieve good adhesion of a coating that may be applied on the granules.

In a further embodiment, the 90% limit (d90) of the particle size distribution as determined by laser diffraction is in the range of 70-200 μm, preferably 100-170 μm. This d90 limit indicates how big particles can be. A rather low d90 limit is beneficial, so as to prevent that a single microsphere would approach the size of a single granule.

In an implementation, the microsphere has a bulk density of at most 200 kg/m3, preferably at most 140 kg/m3, more preferably at most 125 kg/m3. This implies that the microsphere has a density that is at most equal to the density of pyrogenic silica. Preferably, the density is lower.

In one embodiment, the microsphere filler is present in an amount of 1 to 50 weight percent, based on total dry weight of the microporous powder composition. Preferably, the microsphere filler material will reduce the amount of insulation powder without reduction of the amount of opacifier. However, at a higher end of the range, some reduction of the amount of opacifier is foreseen. In a further embodiment, the microsphere filler is present in an amount of 10 to 25 weight percent, based on total dry weight of the microporous powder composition. Good results have been achieved in preliminary experiments with powder compositions comprising microspheres within this range, without need of much adjustment of processing and without major change in the insulation performance.

In one implementation, the microsphere is the only filler that is used in the microporous powder composition. In a further implementation, other fillers or binders may be used as part of the microporous powder composition. Some examples of these fillers and binders are water glass, gypsum, precipitated and amorphous silica, calcium silicate, basic oxides such as magnesium oxide, calcium oxide and barium oxide. While one filler is deemed preferred so as to keep the powder composition and its processing simple, other fillers are not excluded. Preferably, such further fillers are present in an amount not exceeding the amount of the microsphere material and more preferably less than the microsphere filler.

In one embodiment, at least 50% by weight of the insulation powder is chosen from the group selected from pyrogenic silica, pyrogenic alumina or combinations thereof. Preferably, at least 80% by weight of the insulation powder is chosen from the group selected from pyrogenic silica, pyrogenic alumina or combinations thereof. Hence, the insulation powder is preferably a pyrogenic powder instead of an aerogel. Moreover, the amount of non-pyrogenic forms of silica or alumina, such as precipitated silica, microsilica and silica fuse, is at most 50% by weight, and preferably at most 20% by weight. Such non-pyrogenic forms of silica may be suitable for products intended for use at lower temperatures, for instance up to 300° C., but the insulation performance quickly deteriorates upon heating. When the amount of non-pyrogenic forms of silica and alumina is at most 20%, insulation performance can be preserved. In such case, thermal conductivity will increase, but generally less than 10% increase. The temperature limit, i.e. the maximum temperature at which the material may be used without significant deterioration is comparable. Of all non-pyrogenic forms of silica, precipitated silica is most preferred, since it has a comparatively large specific surface area and presence of micropores is assumed. Preferably, at least 90% by weight of the insulation powder is chosen from the group of pyrogenic silica, pyrogenic alumina or combinations thereof. Pyrogenic silica is the name for pyrogenically prepared silicic acids. Alumina, if used, is preferably prepared analogously.

In a preferred implementation, the insulation powder is pyrogenic silica. It is for instance present in an amount of 30 to 90 weight percent, and preferably 40 to 80 weight percent, based on total dry weight of the microporous powder composition. Pyrogenic silica is the name for pyrogenically prepared silicic acids and may include for instance silicic acid, precipitated low-alkali silicic acids, silicon dioxide aerogels. Alumina, if used, is preferably prepared analogously. Microporous powder compositions comprising pyrogenic silica may have a temperature stability up to 1000° C., and have been found appropriate for granulation. If a temperature stability to higher temperatures would be desired, alumina is to be added or used. Particle sizes of the insulation powder is for instance between 2 and 300 nanometers, with a particle size between 4 and 100 nm being more common and a particle size between 4 and 20 nm most common.

In another embodiment, the insulation powder comprises or is a silica aerogel material. Such silica aerogel material may be hydrophobic. Such material is for instance prepared in the manner disclosed in WO2016/054254A2, which is included by reference. While a variety of aerogel materials exist, a silica aerogel (in said patent application referred to as an aerogel composition comprising a silica-based framework) is beneficial for its insulating value. However, its thermal stability is limited. As indicated in said patent application, thermal decomposition would generally start in the temperature range of 300 to 700° C., and in a most preferred embodiment in the range of 500° C. to 650° C. This limited temperature stability is not problematic in some applications, but rather undesired in other applications, for instance, wherein granules are used in heating systems, in heat storage systems, directly adjacent to motors, reactors or vessels configured for high temperature materials.

Opacifiers for use in microporous powder compositions are known, and for instance include titanium oxide, ilmenite, iron (II), iron (III) mixed oxides, chromium dioxide, zirconium oxide, manganese oxide, iron oxide, aluminium oxide, zirconium silicate, silicon carbide. Silicon carbide is a preferred opacifier.

In one further implementation, the microporous powder composition is free from reinforcing fibers. Such fibers are conventionally used to strengthen panel- or block-shape type insulation products. However, in case that the microporous powder composition is used in granules, such as made by dry granulation using roller-compaction, the addition of fibers into the microporous powder composition is not desired, as it may interfere with the processing, and hence the microporous powder composition is preferably free from such fibers. As fibers are not desired, it is surprising that the addition of crystals, such as needle-shaped crystals is not detrimental for the granulation process of the microporous powder composition.

In one implementation, the microporous powder composition comprises the opacifier in an amount of 10-50 wt %, the insulation powder in an amount of 40-80 wt % and said filler in an amount of 1-50 wt %. This has been observed to provide an acceptable powder composition for granulation. Preferably, the powder composition is free of any reinforcing fibers. More preferably, the microporous powder composition comprises the opacifier in an amount of 15-35 wt %, the insulation powder in an amount of 40-80 wt % and said filler in an amount of 5-30 wt %.

In an embodiment according to the invention, the insulation product is in the form of a granulate. Such a product is beneficial, as it may be used by a customer to fill a space, of any simple or complex shape, with the granulate, and therewith generate an insulating layer. In one preferred implementation, the granulate insulation product is used for thermal insulation of heating systems, storage heaters, motors, reactors and/or vessels configured for operation at a high temperature, for instance above 200° C., preferably above or with peak temperatures above 400° C., more preferably above and/or with peak temperatures above 600° C. When intended for use at temperatures of 300° C. and higher, particularly of 400° C. and higher, the insulation powder preferably comprises at least one of pyrogenic silica and pyrogenic alumina, more preferably in an amount of at least 90% by weight of the insulation powder. More preferably, the insulation powder consists of at least one of pyrogenic silica and pyrogenic alumina, for such very high temperature applications.

The granule size is in one implementation in the range of 0.25 to 3.0 mm, as defined by sieving. In an advantageous implementation, the granule size is in the range of 0.25 to 2.5 mm, as defined by sieving. This has been found to be a useful range, creating an optimum between limited dust and appropriate degree of filling and hence insulation value in the ultimate application. Preferably at least 70% by weight of the granules have a size in the range between 0.25 mm and 2.00 mm. In one further embodiment, the granule size is chosen in the range of 0.40 to 2.5 mm, as defined by sieving. In again a further embodiment, the granule size is chosen to be in the range of 0.50 to 2.5 mm, as defined by sieving. The minimum size range may even be 0.8 mm or 1.0 mm.

In a further implementation, the amount of dust being material smaller than 0.25 mm, as defined by sieving, is less than 10% by weight based on the weight of the granules. In order to decrease the level of dust further, the granule size may be optimized, but also a post-treatment may be done onto the granules, for instance with a silicic acid material, such as waterglass. Such a post-treatment may further increase the strength of the granules.

Another and preferred post-treatment resides in the coating of the granules, including application of a hydrophobizing agent. The presence of microspheres as part of the granules enhances adhesion of coating materials. The coating may render the granules more hydrophobic. This is deemed advantageous for incorporation of the granules into a resin. Additionally, the coating encapsulates the microporous material. Therewith the amount of dust will decrease. The amount of such agent may be low, for instance at most 1.0% by weight of the granules, typically less than 0.5% by weight of the granules. Concentrations up to 0.3% by weight or even up to 0.2% by weight may be feasible. For sake of clarity, the amounts herein are weight percentages based on dry weight, and especially applicable to coating by means of a hydrophobizing agent. When applying a coating composition comprising a binder polymer in addition to a silica-compound, the amounts may be higher. However, it is deemed beneficial for sake of thermal conductivity to keep the amount of coating material rather low.

A preferred type of coating material comprises a silica compound. Examples includes halosilanes, alkylsilanes, alkoxysilanes, silazanes, siloxanes, silicone resins and polymers comprising silane- and/or siloxane functional groups. Examples of alkyl- and halosilanes are for instance CH₃SiCl₃, (CH₃)₂SiCl₂, (CH₃)₃SiCl, C₂H₅SiCl₃, (C₂H₅)₂SiCl₂, (C₂H₅)₃SiCl, C₃H₅SiCl₃, (C₃H₈)₂SiCl₂, (C₃H₈)₃SiCl, CH₃Si(OCH₃)₃, (CH₃)₂Si(OCH₃)₂, (CH₃)₃SiOCH₃, C₂H₅Si(OCH₃)₃, (C₂H₅)₂Si(OCH₃)₂, (C₂H₅)₃SiOCH₃, C₈H₁₅Si(OC₂H₅)₃, C₈H₁₅Si(OCH₃)₃. Silicone resins, such as polydimethylsiloxane are deemed preferred. Silicone resins may have the general formula R-SiXn, wherein R is selected from the group consisting of alkoxy and acetoxy, such as acrylate, methacrylate, glycidoxy, epoxy propoxy, epoxy cyclohexyl, and vinyl, and X is selected from the group of halogen, alkoxy and acetoxy. These silicones are hydrophobic film forming compounds which are available in aqueous or organic solvent solution, emulsion or dispersion forms. In case of using monomeric silanes, these may further be adhesion promotors in a coating composition as known per se, typically based on resin, such as epoxyresin, acrylate or the like. In a further option, an inorganic coating, such as waterglass or colloidal silica can be used.

Alternative hydrophobic coating materials include but are not limited to long chain aliphatic fatty acids and salts having from 12 to 24 carbon atoms, such as stearic acid, calcium stearate or ammonium, metallic or organic base salts of lauric, oleic or palmitic acids. Waxy members of the alkane paraffin series and/or low molecular weight polyalkylenes having molecular weights from 280 to 30,000 may be used. Polyalkylene glycols, for instance having a molecular weight from 700 to 6000, such as (methoxy- or ethoxy) polyethylene glycol may be used.

In one implementation, the microporous powder composition is used in a granulate has a nominal tap density of at most 250 g/l. Preferably, the nominal tap density is at most 220 g/l, preferably at most 200 g/l, even in the range of 170-190 g/l. Lowering the tap density may be achieved by adaptation of the pressure applied in the roller-compaction step of the dry granulation. Herein, the gypsum filler may contribute to achieving the lower densities. Such lower densities are desired, as the thermal conductivity decreases with the density.

Granulation of the microporous powder composition to granules is preferably performed by dry granulation, and more preferably using a roller-compaction step. A roller compaction step involves the use of equipment provided with at least two counter-rotating rollers, between which the powder composition is continuously compressed using a controlled compaction force. The granule size is defined in a subsequent size reduction step, for instance in a sieve mill. Particles below the size limit of a sieve screen of the sieve mill, or in a separate sieve downstream of the mill may be recirculated to the roller-compactor used in the roller-compaction step.

The granulate of the invention can be used for thermal insulation. The granulate can preferably be used in insulation mixtures or formulations. The corresponding thermal insulation mixtures and/or formulations may comprise at least one solvent and/or binder and/or a filler.

The solvent may be selected from the group consisting of water, alcohols, aliphatic and aromatic hydrocarbons, ethers, esters, aldehydes, ketones and mixtures thereof. Solvents used may, for example, be water, methanol, ethanol, propanol, butanol, pentane, hexane, benzene, toluene, xylene, diethyl ether, methyl tert-butyl ether, ethyl acetate, acetone.

The binder may comprise organic or inorganic substances. The binder preferably comprises reactive organic substances. Organic binders may be selected, for example, from the group consisting of (meth)acrylates, alkyd resins, epoxy resins, gum arabic, casein, vegetable oils, polyurethanes, silicone resins, wax, cellulose gum. Such reactive organic substances can lead, for example, via polymerization, crosslinking reaction or another type of chemical reaction, to curing of the thermally insulating formulation used and/or of the thermally insulating mixture.

Additionally or alternatively to the organic binder, the thermally insulating formulation and/or the thermally insulating mixture may comprise inorganic curable substances. Inorganic binders, also referred to as mineral binders, have essentially the same function as the organic binders: that of binding admixtures to one another. In addition, inorganic binders are divided into non-hydraulic binders and hydraulic binders. Nonhydraulic binders are water-soluble binders such as white lime, dolomite lime, gypsum and anhydrite, which cure solely under air. Hydraulic binders are binders that cure under air and under water and are insoluble in water after curing. These include hydraulic limes, cements, and render and masonry binders.

It is observed for clarity that any of the embodiments discussed hereinabove, specified in dependent claims and/or apparent from the examples are deemed applicable to any of the aspects of the invention. Parameter values given in the present specification are measured in accordance with the methods specified hereinbelow, unless otherwise indicated or known per se. Any reference to the weight percentage herein expressed as wt. % or % by weight refers to the same. The reference is the total powder composition, which is a dry composition, unless otherwise indicated.

### EXAMPLES AND FIGURES

These and other aspects of the invention will be further elucidated in following examples. FIG. 1 is a graph of experimental data obtained in accordance with Example 2 showing the thermal conductivity (TC) as a function of temperature.

### Measurement Methods

Compressive strength is measured in following manner: granules are pressed into a metal die. A universal test machine of 500 kN load cell is used with cross head speed of 1 mm/min. The maximum force and displacement are recorded continuously during compression and the stress is calculated therefrom.

Tap or tapped density is an increased bulk density attained after mechanically tapping a receptacle containing the sample of powder or granule. The tapped bulk density is obtained by mechanically tapping a graduated measuring cylinder or vessel containing the sample. After observing the initial untapped bulk volume (V0) and mass (m0) of the sample, the measuring cylinder or vessel is mechanically tapped, and volume or mass readings are taken until little further volume or mass change is observed. The mechanical tapping is achieved by raising the cylinder or vessel and allowing it to drop, under its own mass, a specified distance. Devices that rotate the cylinder or vessel during tapping may be preferred to minimize non-uniformity during tapping down.

Thermal conductivity is measured at equilibrium using a cell with a diameter of 110 mm and a height of 100 mm. A heat source in the form of a cylindrical heating element is hanged in the middle with controlled power supply. Insulation is present circumferential to the cylindrical heating element. At the outside, a metal can is present. The thermal conductivity of the material is obtained from the temperature difference (between hot/cold face temperatures) and heat transfer cross cylindrical section. An effective area for the heat transfer is calculated, and hot & cold face temperatures (HF, CF) are recorded. The thermal conductivity γ in mW/mK is calculated as γ=0.956×Power supply/ΔT (HF−CF)−0.0036. This method has been developed by applicant in collaboration with the National Physical Laboratory (NPL) in the UK. The resulting values for the thermal conductivity are approximately 15% higher than those measured in accordance with ISO 8302.

Shrinkage is dimensional shrinkage of alumina crucibles of fixed size. The crucibles are filled up to the top to settlement density. The filled crucible is put into the furnace during 24 hours at 1000° C. Then, the furnace is switched off, and cooled down to temperature (typically within 30 minutes). The height drop of the granules and crucible is measured as the shrinkage value for the product.

### Example 1

Microporous powder compositions were generating by mixing pyrogenic silica as insulation powder, and silicon carbide as opacifier and optionally a filler. The pyrogenic silica had a specific surface area in the range of 200-250 m2/g as measured by the BET method and was hydrophilic (i.e. not treated with a hydrophobation agent). The powder compositions were thereafter subjected to dry granulation, which comprises a roller-compaction step using equipment provided with at least two counter-rotating rollers, between which the powder composition is continuously compressed using a controlled compaction force. The compaction force or pressure was set to achieve a desired tap density, which was 240 g/l in the examples. The bulk density was 200 g/l. The dry granulation furthermore included a size reduction step downstream of said roller-compaction step. Use was made of a sieve mill. The final sieve size in the sieve mill was set to 310 microns. The granule size was such that at least 70 wt % of the granules had a size within the range 0.25 mm and 2.00 mm. In all examples, the granule formation was identical.

In examples of the invention, the powder composition was modified by inclusion of a filler. The amount of filler was 20%, the amount of pyrogenic silica was 50% and the amount of opacifier was 30%, all in weight percent. In the reference example, the amount of filler was 0%, the amount of pyrogenic silica was 70% and the amount of opacifier 30%. All samples were granulated to a tap density of 240 g/l and a bulk density of 200 g/l. The perlite microsphere was obtained from Siniat, comprising 80% SiO2 and 13% Al2O3, 5% K2O and 3% Na₂O (the total being 100%). The bulk density was 115 kg/m³ and the d50 (mean size) was 70 μm. Perlite microspheres are a special subset of perlite fillers and require advanced manufacturing and classification techniques to produce. They consist of discrete hollow spheres of expanded perlite—generally between 10 and 300 micrometer in size. Densities vary from 96 to 450 kg/m3. The used perlite microspheres had a very high purity. Typically, expanded perlite further comprises minor quantities of up to 1% or 2% of Titanium dioxide, Magnesium oxide, Iron oxide (Fe2O3) and Quick lime (CaO), which contaminations deteriorate the insulation properties.

TABLE 1
Test results

| Example | Reference | Invention |
|---|---|---|
| Filler | None | Perlite |
| | | microspheres |
| Filler (%) | 0 | 20 |
| pyrogenic silica (%) | 70 | 50 |
| Thermal conductivity at 200° C. (mW/m · K) | 30 | 32 |
| Thermal conductivity at 400° C. (mW/m · K) | 40 | 46 |
| Dust (wt %) | 7% | 9% |
| Granule strength (kPa) | 155 | 159 |
| Shrinkage after 24 hours heating treatment at | <3 | <5 |
| 1000° C. (%) | | |

The results in Table 1 indicate that the perlite microsphere is effective as a filler. The increase in thermal conductivity at 200° C. and 400° C. is limited. Moreover, there is a slight strength increase, which may indicate that the density can be further reduced, leading to better thermal conductivity. It is observed that the shrinkage is particularly advantageous when compared to data provided in WO2006/097688A1. In the said patent application, shrinkage was identified after a 24 hours heat treatment at 900° C., whereas the heat treatment of the present examples was carried out at 1000° C. The shrinkage after a heat treatment at 900° C. would be 1-2% lower.

Based on these preliminary experiments, the microporous powder composition and the granulation process may be further optimized, for instance to achieve a lower density with lower thermal conductivity.

1. A microporous powder composition, comprising an insulation powder chosen from alumina and silica, and an opacifier and a filler, wherein the filler is a hollow microsphere of inorganic material.

2. The microporous powder composition of claim 1, wherein the microsphere comprises at least 88% by weight of oxides chosen from silica and alumina.

3. The microporous powder composition of claim 2, wherein the microsphere comprises at least 90% by weight of oxides chosen from silica and alumina.

4. The microporous powder composition in of claim 1, wherein the microsphere comprises at most 9% by weight of alkaline oxides.

5. The microporous powder composition of claim 1, wherein the filler is a perlite microsphere.

6. The microporous powder composition of claim 1, wherein the microsphere has a bulk density of at most 200 kg/m³.

7. The microporous powder composition of claim 1, wherein the microsphere has a mean particle size (d50) as determined by laser diffraction in the range of 25-90 μm.

8. The microporous powder composition of claim 1, wherein the 90% limit (d90) of the particle size distribution as determined by laser diffraction is in the range of 70-200 μm.

9. The microporous powder composition of claim 1, wherein the filler is present in an amount of 1 to 50 weight percent, based on total dry weight of the microporous powder composition.

10. The microporous powder composition of claim 9, wherein the filler is present in an amount of 10 to 25 weight percent, based on total dry weight of the microporous powder composition.

11. The microporous powder composition of claim 1, wherein the insulation powder is pyrogenic silica.

12. The microporous powder composition of claim 1, wherein microporous powder composition is free of fibers.

13. An insulation product comprising the microporous powder composition of claim 1, wherein the insulation product is a granulate.

14. The insulation product of claim 13, wherein a coating is applied to the granules of the granulate.

15. A filled polymer material comprising an insulation filler, wherein said insulation filler is an insulation product of claim 13.

16. Use of the microporous powder composition of claim 1 for the manufacture of an insulation product, wherein the manufacture comprises granulation.

17. The use of claim 16, wherein the granulation comprises a roller compaction step.

18. The use of claim 16, wherein the granulation is configured to provide granules with a granule size in the range of 0.2 to 3 mm, as defined by sieving.

19. The use of claim 16, wherein the granules are manufactured with a tap density of less than 250 g/l.

20. The insulation product of claim 14, wherein the coating is a silicone material.
